(19) United States
(12) Patent Application Publication
(10) Pub. No.: US 2024/0061717 A1
(43) Pub. Date: Feb. 22, 2024

(54) BATCH JOB REHYDRATION

(71) Applicant: Capital One Services, LLC, McLean, VA (US)

(72) Inventors: Venkata Satya Parcha, Mckinney, TX (US); Harshil Patel, Frisco, TX (US); Praveen Kumar Singh, Plano, TX (US); Manish Kumar, Columbus, OH (US); Nirbhay Kumar Singh, Plano, TX (US)

(21) Appl. No.: 17/891,507

(22) Filed: Aug. 19, 2022

(51) Int. Cl. G06F 9/50

(52) U.S. Cl. CPC G06F 9/505; G06F 9/5077; G06F 9/5072; G06F 2209/505

(57) ABSTRACT

A method, apparatus, and computer-readable medium are described that enable agent instances to be instantiated in containerized environments. When a new container is detected, a list of agent instances expected to be running in a compute instance or in a container may be obtained and compared with status information regarding which agent instances are active. For a non-active agent instance, an agent object and configuration information for the agent instance may be obtained from a storage. Based on the available name, the agent object, and the configuration information, the agent instance may be instantiated and connected to an agent status server. An application related to the new agent instance may be deployed.

### TECHNOLOGICAL FIELD

Aspects of the disclosure relate generally to cloud-based data processing operations.

### BACKGROUND

Various cloud-based services may be scaled, as needed, to handle variable processing demands of preset processes. These scalable cloud-based services provide increased processing power to accommodate intervals when the demands are high, while reducing the available processing power when demands are low. To accommodate the fluctuating demand, scalable services may dynamically adjust a quantity of virtual processors available to existing quantity of processes. Other on-line services include scalable container-based services where developers may increase or decrease a quantity of available containers to accommodate varying processing demands. One or more agents, per compute instance, may be used to manage batch jobs performed by containers in the compute instances. When the processes are virtualized in containers, scaling the processes entails increasing the quantity of containers and associated processes, not the computing power available to any given process. At least one reason for the complicated process of bringing new containers online includes the existence of third-party agents that are not well-integrated with the container-based service. Attempts to scale container-based processes may encounter difficulties upon startup as new instances of third-party agents often require individual, manual instantiation when new containers are started. Dynamically adding new containers with third party agents to support an existing container-based service has proven difficult.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

One or more aspects relate to enabling container-based, data processing services to dynamically populate new containers with agents. A self-executing process, executing on a computing device, may be initiated when a new container is detected. The process may obtain a list of agents (native agents, third-party agents, or a combination of native agents and third-party agents) across multiple containers and determine which agent, for the new container, is inactive. Configuration information for the inactive agent may be obtained, from a storage containing agent configurations, by the process. Using the retrieved configuration information, an instantiation process may be initiated to instantiate the inactive agent using the retrieved configuration information. In addition to instantiating the inactive agent, the instantiation process may connect the newly instantiated agent to a server configured to monitor deployed agents in container. Once connected to the server, the newly instantiated agent may be assigned, as part of a task handled by the new container, to perform operations on behalf of a batch-based application. A benefit of the rehydration method and related systems described herein includes the ability of the method to instantiate both native agents (e.g., agents native to the container service) as well as third-party agents requiring specific configurations. In some aspects, the self-executing process may monitor how often rehydration of an inactive agent was unsuccessfully attempted. Upon satisfying a threshold of unsuccessful attempts to instantiate the inactive agent, the new container may be inactivated. Based on the inactivation of the new container, a replacement container may be created.

Aspects of the disclosure relate to a computer-implemented method for instantiating agents in container may include determining whether a container, having a processing task performed by one or more instances of agents, has been deployed; receiving, based on a determination that the container has been deployed, a list of the one or more instances of agents for the container; and receiving, based on the determination and from an agent status server, statuses of the one or more instances of agents. The method may also include determining, based on the list of agents and the statuses of the one or more instances of the agents, whether an instance of an agent of the one or more instances of the agents is inactive; receiving, from an agent object repository and based on a determination that the instance of the agent is inactive, an agent object corresponding to the agent; receiving, from an agent configuration repository and based on a determination that the agent is inactive, configuration information for the instance of the agent; and attempting to instantiate, based on the agent object and the configuration information, the instance of the agent. The attempt to instantiate the instance of the agent may include attempting to connect the instance of the agent to the agent status server. In additional aspects, the method may further include providing, to the agent status server, a status of the instance of the agent. In further aspects the method may include storing configuration information of the instance of the agent in the agent configuration repository. In yet further aspects the method may include determining, based on the attempt to instantiate the instance of the agent, whether the instantiation of the instance of the agent was successful; receiving, based on a determination that the attempt to instantiate the instance of the agent failed and from the agent object repository, a replacement agent object corresponding to the agent; receiving, from the agent configuration repository and based on the determination that the attempt to instantiate the instance of the agent failed, replacement configuration information for the instance of the agent; and attempting to instantiate, based on the replacement agent object and the replacement configuration information, a replacement instance of the agent.

In some aspects, the method may include retrieving a quantity threshold of attempts to instantiate the replacement instance of the agent; determining whether the quantity threshold of attempts has been satisfied and the replacement instance of the agent has not been successfully instantiated; and inactivating, based on a determination that the quantity threshold of attempts has been satisfied and the replacement instance of the agent has not been successfully instantiated, the container. In some aspects, the method may include attempting to connect, based on a successful attempt to instantiate the instance of the agent, the instance of the agent to the processing task in the container.

In some aspects, the method may include determining, based on the attempt to connect the instance of the agent, whether the attempt to connect the instance of the agent to the processing task was successful; receiving, based on a determination that the attempt to connect the instance of the agent to the processing task failed and from the agent object repository, a replacement agent object corresponding to the agent; receiving, from the agent configuration repository and based on the determination that the attempt to connect the instance of the agent to the processing task failed, replacement configuration information for the instance of the agent; instantiating, based on the replacement agent object and the replacement configuration information, a replacement instance of the agent; and attempting to connect, based on the instantiation of the replacement instance of the agent, the replacement instance of the agent to the processing task in the container.

In some aspects, the method may include retrieving a quantity threshold of attempts to connect the replacement instance of the agent to the processing task in the container; determining whether the quantity threshold of attempts has been satisfied and the replacement instance of the agent has not been successfully connected to the processing task; and inactivating, based on a determination that the quantity threshold of attempts has been satisfied and the replacement instance of the agent has not been successfully connected to the processing task, the container.

Additional aspects, configurations, embodiments, and examples are described in more detail below.

### BRIEF DESCRIPTION OF THE SEVERAL VIEWS OF THE DRAWINGS

The present disclosure is illustrated by way of example and not limited in the accompanying figures in which like reference numerals indicate similar elements and in which:

FIG. 1 depicts an example of a computing device and system architecture that may be used in implementing one or more aspects of the disclosure in accordance with one or more illustrative aspects discussed herein;

FIG. 2 depicts a block diagram of an environment in which systems and/or methods described herein may be implemented;

FIG. 3 depicts a diagram showing interactions between agent objects, agent instances, and containers;

FIG. 4 shows relationships between a scalable service and an elastic container service;

FIG. 5 shows a flowchart of a process for rehydrating agent instances; and

FIG. 6 shows a flowchart of a process for rehydrating agent instances.

It will be recognized by the skilled person in the art, given the benefit of this disclosure, that the exact arrangement, sizes and positioning of the components in the figures is not necessarily to scale or required.

### DETAILED DESCRIPTION

Certain aspects relate to improving how agents are deployed in an expandable container service. To accommodate fluctuating data processing demands, some cloud-based services are scalable. For instance, Amazon Web Services (AWS), a subsidiary of Amazon.com of Bellevue, Washington, offers the Amazon Elastic Compute Cloud (EC2) service that permits users to rent virtual computers on which to run their own applications. AWS also offers the Amazon Elastic Container Service (ECS) that permits users to define, execute, and scale container-based applications. In some environments, agents, configured to operate in containers, may be provided with preset names to allow persistent connections between workload management servers and servers performing the work. In these environments, when an agent is named and installed, a unique key string identifier file may be generated in order to authenticate the agent with the workload server for future installations. As such, only one instance of an agent with the predefined name may be active at a time as the workload management server may be configured to send work requests based on the predefined names. Where two agent instances share the same names, a conflict may arise as the workload server may not be able to determine which agent is associated with which task. Similarly, the workload server may not be able to resolve communications between the agents. The predefined set of names forced developers to manually instantiate agents in containers to prevent conflicts.

One or more aspects of the disclosure relate to a framework for managing how agent instances of container may be monitored and, when inactive, re-instantiated. In one or more aspects, an automation process detects when a new container has been created. In response, the automation process receives a list of agents from a remote location. The list may contain a list of names of available registered agents. The automation process may invoke an application programming interface (API) that identifies the inactive agent to the API and, in response, receives configuration information for the inactive agent. A collection of agent configuration information may be stored separate from the container-based service. For instance, the collection of agent configuration information may be stored in a remote server. The collection of agent configuration information may be stored in a cloud-based storage.

During operation, a computing cluster may provide various services. Those services may be handled by one or more compute instances in the cluster. Each compute instance may include one or more containers. A compute instance may provide its portion of the service by performing one or more tasks via containers in the compute instance. A given task may be performed in container. One or more separate containers may be provided in the compute instance. As an example, the containers may be “dockerized” (e.g., via dockerizing a Node.js application to be executable on various platforms in accordance with extensible services provided by Docker Inc., such as at docker.com). The containers may be supported by other extensible services. Each container may be controlled by one or agent instances. The one or more agent instances may be resident in the containers and/or separate from the containers. The one or more agent instances may be made available for performing the one or more tasks by connecting the one or more agent instances to one or more servers that delegate processing tasks. When an agent instance receives a processing job request, the agent may perform the job in one of the containers and return the results of the job.

In one or more aspects, a process for autonomously instantiating agents for new containers may be realized as follows: upon startup of a container, invoke a startup process; obtain, via the startup process, a list of registered agent names; determine, via the startup process and using API connected to an agent status server, whether, for the new container, whether any agent instance for the given container/compute instance is inactive (e.g., un-instantiated); receive, from an agent object storage, using which agents are expected to be instantiated in the container; instantiate, via the startup process and for the container, any inactive agent and connect the newly instantiated agent to the agent status server; and, upon successful instantiation of the agent and connection to the agent status server, deploy the batch job using the new container and instantiated agent.

In some examples, the startup process may handle all agent instantiation and container deployment processes. The agent instantiation may be handled by the startup process and a container deployment handled by a separate process. Where separate processes are used, the processes may be found in the new container, in the compute instance, and/or in other locations. The processes may be co-located or located separate from each other.

Agent objects may be provided in one or more computer-readable information forms (e.g., one or more tables and/or one or more records in one or more databases) by the agent object storage. Agent objects may comprise templates for the creation of agent instances for installation in environments to facilitate the execution of the batch jobs. The agent instances, which control and/or monitor applications executing in containers, may be instantiated in containers, in compute instances, and/or remote from the compute instances.

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. Any sequence of computer-implementable instructions described in this disclosure may be considered to be an “algorithm” as those instructions are intended to solve one or more classes of problems or to perform one or more computations. While various directional arrows are shown in the figures of this disclosure, the directional arrows are not intended to be limiting to the extent that bi-directional communications are excluded. Rather, the directional arrows are to show a general flow of steps and not the unidirectional movement of information. In the entire specification, when an element is referred to as “comprising” or “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software. In addition, terms such as “ . . . unit”, “ . . . module” described in the specification mean a unit for performing at least one function or operation, which may be implemented as hardware or software, or as a combination of hardware and software. Throughout the specification, expression “at least one of a, b, and c” may include ‘a only’, ‘b only’, ‘c only’, ‘a and b’, ‘a and c’, ‘b and c’, and/or ‘all of a, b, and c’.

It is noted that various connections between elements are discussed in the following description. It is noted that these connections are general and, unless specified otherwise, may be direct or indirect, and that the specification is not intended to be limiting in this respect. As described herein, thresholds are referred to as being “satisfied” to generally encompass situations involving thresholds above increasing values as well as encompass situations involving thresholds below decreasing values. The term “satisfied” is used with thresholds to address when values have passed a threshold and then approaching the threshold from an opposite side as using terms such as “greater than”, “greater than or equal to”, “less than”, and “less than or equal to” can add ambiguity where a value repeated crosses a threshold.

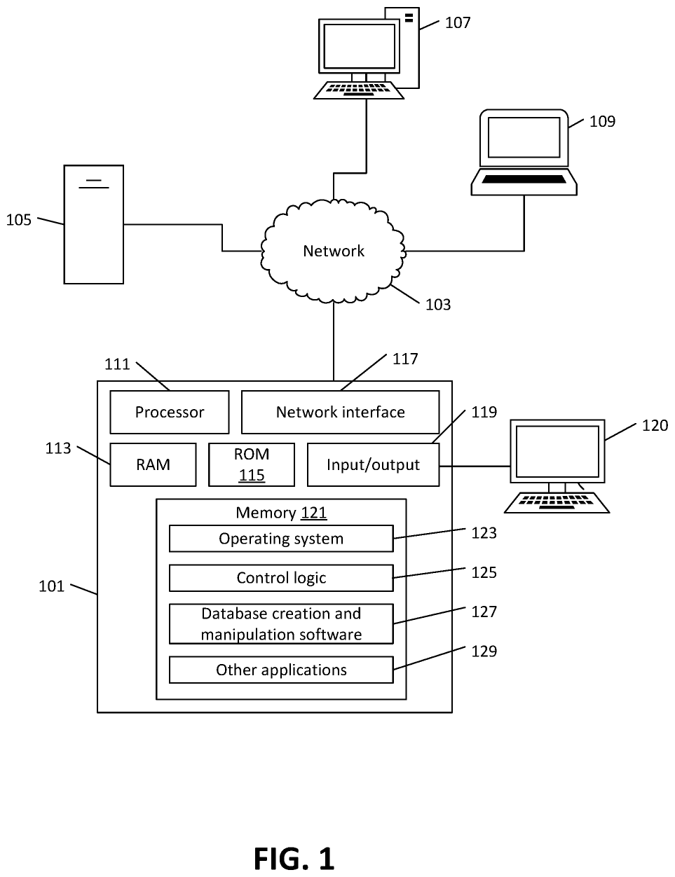

Before discussing the concepts of the disclosure in greater detail, however, several examples of a computing device that may be used in implementing and/or otherwise providing various aspects of the disclosure will first be discussed with respect to FIG. 1. FIG. 1 illustrates one example of a computing device 101 that may be used to implement one or more illustrative aspects discussed herein. For example, the computing device 101 may, in some embodiments, implement one or more aspects of the disclosure by reading and/or executing instructions and performing one or more actions based on the instructions. In some embodiments, the computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

The computing device 101 may, in some embodiments, operate in a standalone environment. In others, the computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media. Additionally or alternatively, the computing device 101 and/or the network nodes 105, 107, and 109 may be a server hosting one or more databases.

As seen in FIG. 1, the computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with database operations. Input/output 119 may include a variety of interface units and drives for reading, writing, displaying, and/or printing data or files. Input/output 119 may be coupled with a display such as display 120. Memory 121 may store software for configuring computing device 101 into a special purpose computing device in order to perform one or more of the various functions discussed herein. Memory 121 may store operating system software 123 for controlling overall operation of the computing device 101, control logic 125 for instructing the computing device 101 to perform aspects discussed herein, database creation and manipulation software 127 and other applications 129. Control logic 125 may be incorporated in and may be a part of database creation and manipulation software 127. In other embodiments, the computing device 101 may include two or more of any and/or all of these components (e.g., two or more processors, two or more memories, etc.) and/or other components and/or subsystems not illustrated here.

Devices 105, 107, 109 may have similar or different architecture as described with respect to the computing device 101. Those of skill in the art will appreciate that the functionality of the computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Python, JavaScript, or an equivalent thereof. The computer executable instructions may be stored on a computer readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product. Having discussed several examples of computing devices which may be used to implement some aspects as discussed further below, discussion will now turn to a method for classifying textual data using a machine-learning classifier.

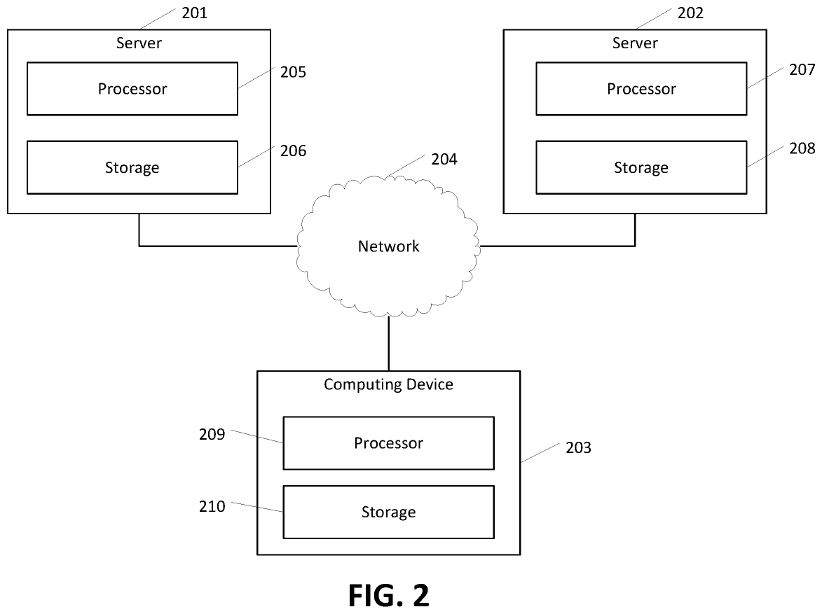

FIG. 2 is a block diagram of an environment in which systems and/or methods described herein may be implemented. As shown in FIG. 2, the environment may include servers 201 and 202 and a computing device 203 connected by a network 204. The devices, servers, and network may be interconnected via wired connections, wireless connections, or a combination of wired and wireless connections. The server 201 may be directed toward receiving files relating to activities from computing device 203 and then sending the files to server 202 for processing.

The network 204 may include one or more wired and/or wireless networks. For example, network 204 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more servers shown in FIG. 2 may be implemented within a single server, or a single server shown in FIG. 2 may be implemented as multiple, distributed servers or in a cloud-based computing environment. A set of devices (e.g., one or more devices) of the environment 203 may perform one or more functions described as being performed by another set of devices of the environment. Network 204 may be represented as a single network but may comprise combinations of other networks or subnetworks. For example, the server 201 may store, in storage 206, the list of registered agent names, the statuses of the agents, and the agent objects. The processor 205 of the server 201 may provide, upon request, the registered agent names, the statuses of the agents, and requested agent objects. One or more of these may be obtained via an exposed API.

Storage 208 of server 202 may include a cluster with one or more compute instances. Each compute instance may include one or more tasks. Each task may be performed by a container. Other relationships between compute instances, tasks, and container may be used. The startup process may be executed by processor 207. The startup process may be executed by processor 209 of the computing device 203.

The computing device 203 may store, in storage 210, data to be processed by job applications. The data may be processed, by processor 207, in batches by the applications implemented using the containers. The agents may be deployed by providing their information to the computing device 203 such that, using the information of the agents, the computing device 203 may send batches of data from the storage 210 to the server 202 and may identify which agents are tasked to handle the batches of data. The new containers may be deployed by providing their information to the computing device 203 such that, using the information of the new containers, the computing device 203 may send batches of data from the storage 210 to the server 202 and may identify which containers responsible for handling the batches of data. An intermediate load balancing server may be used to balance batch job requests from the computing device 203 by directing the batch job requests to available agents/containers. The intermediate load balancing server may monitor the status of the agents, as reported to the storage 206, to ensure the batch job requests are being sent to currently available agents or containers.

To assist with explanation of the concepts described here, the disclosure includes the following sections: Rehydrating Agents and Containers; Container-based Environments with Scalable Services; and Processes for Rehydration.

### Rehydrating Agents and Containers

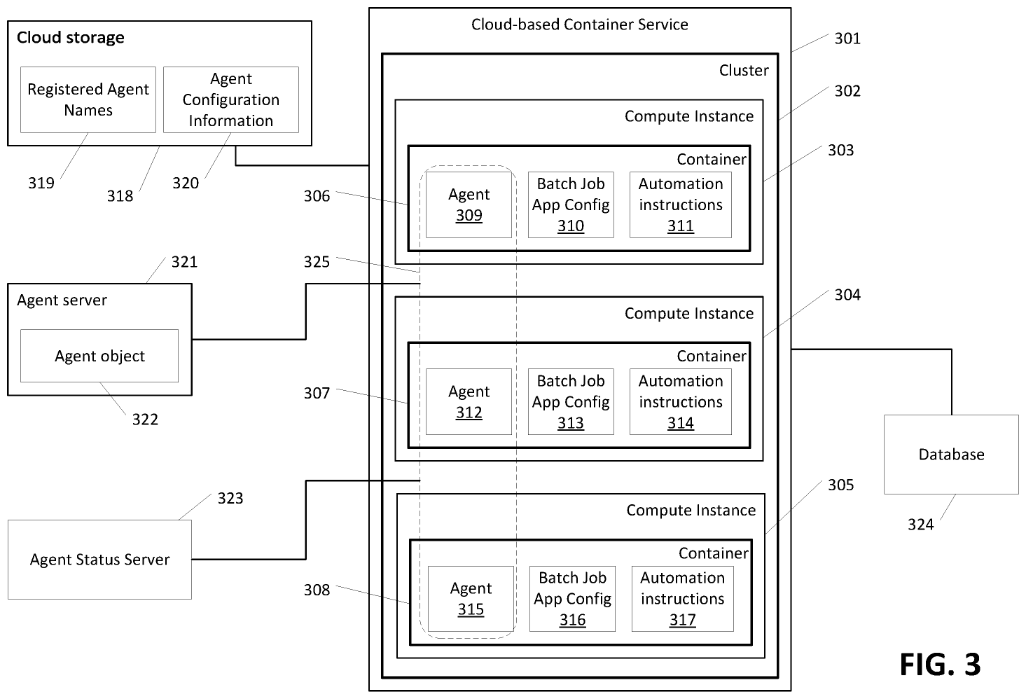

FIG. 3 depicts a diagram showing interactions between agent objects, agent instances, and compute instances. A cloud-based container service 301 may comprise one or more clusters. FIG. 3 shows a cluster 302 as an example. The cluster 302 may include one or more compute instances 303, 304, or 305. Compute instance 303 may comprise a container 306. Compute instance 304 may comprise a container 307. Compute instance 305 may comprise a container 308. Container 306 may include an agent instance 309, batch job configuration instructions 310, and automation instructions 311. Container 307 may include an agent 312, batch job configuration instructions 313, and automation instructions 314. Container 308 may include an agent 315, batch job configuration instructions 316, and automation instructions 317. While shown in the respective containers, the automation instructions 311, 314, or 317 may be provided separately from their respective containers 306, 307, and 308. The automation instructions 311, 314, or 317 may handle instantiation of the agents in their container as well as connecting a job application of each container 307 to a server that sends data for processing by the batch job applications. The server that sends data to the batch job applications may be the agent server 321, the database 324, or another server or servers. In one or more examples, the agent instances 309, 312, or 315 may include one or more third party agents (shown generally with dashed lines as agent instances 325).

FIG. 3 may also comprise a cloud storage 318 that contains a list of registered agent names 319 and agent configuration information 320. The list of registered agent names 319 may identify the list of available agent names that are currently not being used by other instantiated agents. The agent configuration information 320 may include configuration details for instantiating an agent as associated with a container (e.g., in the container, in the compute instance, or separate from but monitoring or interacting with the application running in the container). An agent server 321 may include one or more agent objects 322 that may be instantiated using the agent configuration information 320. An agent status server 323 may receive status information from the agents instances 309, 312, or 315 (collectively, agents 325). The agent status information stored in the agent status server 323 may be accessed via an application programming interface (API). For instance, the automation instructions 311, 314, or 317 may request a status of all agents associated with a container. Based on a response of the agent status or statuses, the automation instructions 311, 314, or 317 may request, for the inactive agent instance, the relevant agent object 322 from the agent server 321 and the agent configuration information 320 from the cloud storage 318. The automation instructions 311, 314, or 317 may also request an available agent name (or list of available names) from the list of registered agent names 319. Based on the agent object 322, the agent configuration information 320, and the available agent name (from the list of available agent names 319), the automation instructions 311, 314, or 317 may instantiate the inactive agent instance.

The automation instructions 311, 314, or 317 may attempt to connect the newly instantiated agent (e.g., agent instances 309, 312, or 315) with the agent status server 323. Based on that connection, the newly instantiated agent (e.g., agent instances 309, 312, or 315) may provide its status to the agent status server 323. The agent status server 323 may store the status of the newly instantiated agent and any of the other agents (collectively, agents 325). If one of the agents 325 becomes inactive (e.g., the container 306, 307, or 308 being inactivated or otherwise unavailable), the agent status server 323 may store the lack of status from the relevant agent.

The process for autonomously instantiating agents for new containers may include, upon startup of the container 306, invoke the automation instructions 311 by, for instance, one or more of processors 205, 207, 209, or combination of processors of FIG. 2. The automation instructions 311 may control the one or more processors to obtain, from the cloud storage 318, an available registered agent name or a list of available registered agent names 319. The automation instructions 311 may further control the one or more processors to determine, using the API connected to the agent status server 323, whether, for the new container 306, any agent instance for the given container 306 is inactive (e.g., un-instantiated). The automation instructions 311 may further control the one or more processors to determine, using the API connected to the agent status server 323, whether, for the new container 306, any agent instance for the given compute instance 303 is inactive. The automation instructions 311 may further control the one or more processors to receive, from the agent server 321, the agent object 322 corresponding to the un-instantiated agent that is expected to be instantiated in the container 306 or in the compute instance 303. The automation instructions 311 may further control the one or more processors to instantiate the inactive agent instance using the available name from the list of registered agent names 319 (and select one if needed), the agent object 322, the configuration information 320 for the agent instance, or a combination of the available name and configuration information 320. The automation instructions 311 may further control the one or more processors to connect the newly instantiated agent instance 309 to the agent status server 323. Upon successful instantiation of the agent and connection to the agent status server, the automation instructions 311 may further control the one or more processors to deploy the batch job (handled by the newly instantiated agent 309 using the container 306) as available to handle processing requests sent to it (from the agent server 321, from the database 324, or from another server for tasks related to the respective server or database). Instructions to deploy the batch job may be separately provided as batch job configuration instructions 310, 313, or 316.

Container-Based Environments with Scalable Services

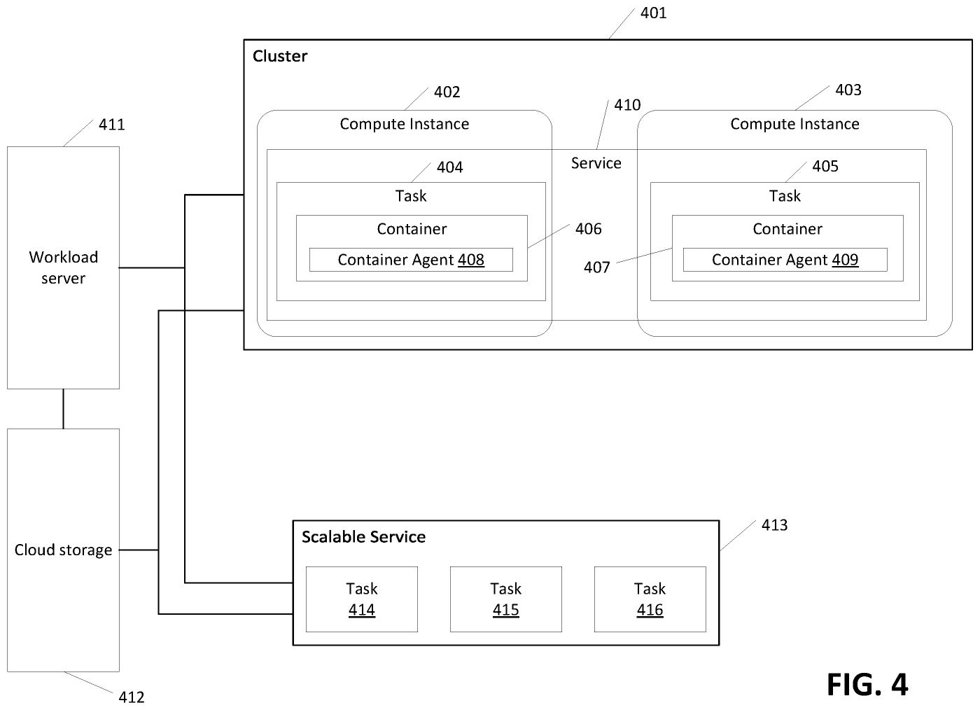

FIG. 4 shows relationships between a scalable service and an elastic container service. A cluster 401 may contain a quantity of compute instances 402 and 403. Together the compute instances 402 and 403 may provide one or more services (e.g., shown as service 410). Each compute instance 402 or 403 may support a task 404 or 405 as part of the service 410. Each task 404 or 405 may be performed by a container 406 or container 407, respectively. The containers 406 and 407 may be managed by container agents 408 or 409, respectively. The container agent 408 may be associated with the container 406. The container agent 409 may be associated with the container 407.

The cluster 401 may be connected with a workload server 411, a cloud storage 412, a scalable service 413 (with one or more scalable tasks 414, 415, and 416), or combination of components of FIG. 2. The workload server may use the service 410 provided by the cluster 401, such as by sending data to be processed using one or more tasks 404 or 405. Which individual container 406 or 407 that handles the task for the incoming data may be decided by the workload server 411, by the container agent 408 or 409, by the scalable service 413, and/or other server (e.g., a load balancing server or servers—not shown in FIG. 4.).

### Processes for Rehydration

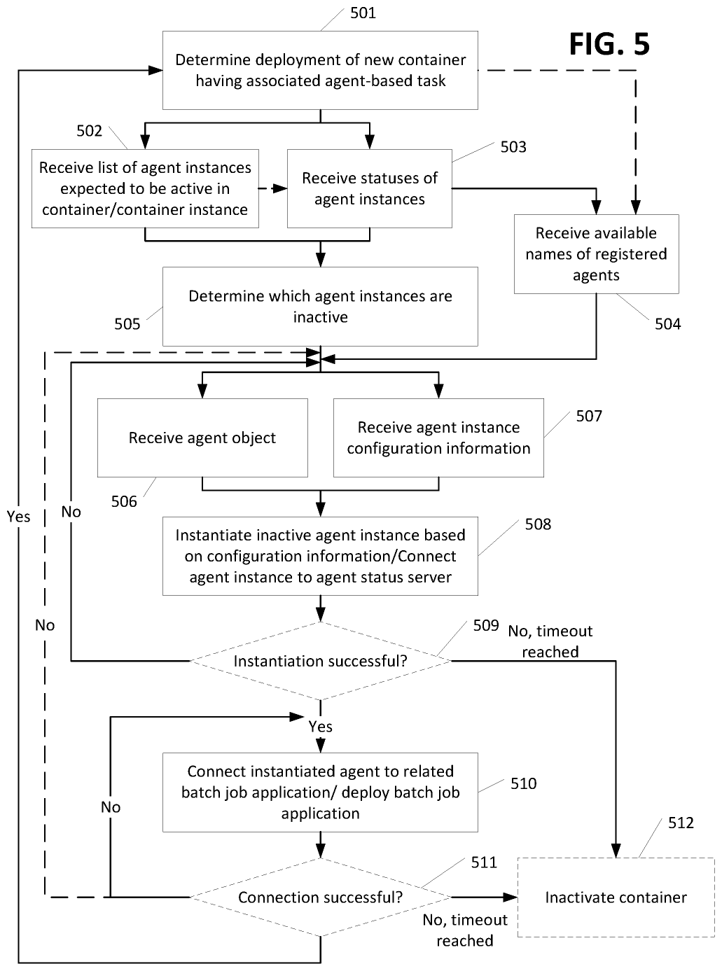

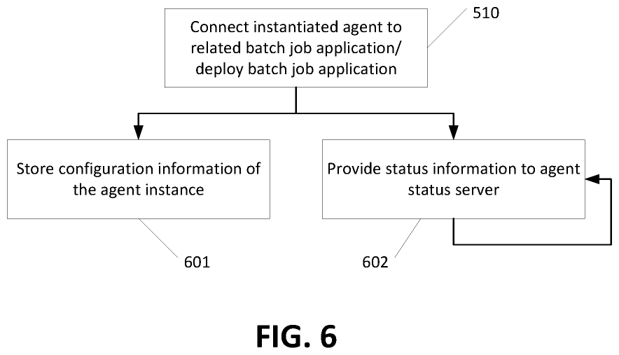

FIGS. 5 and 6 show flowcharts of processes for rehydrating agent instances. In step 501, a process determines that a new container has been deployed, where the new container may be associated with an agent-based task. In step 502, a list of agent instances expected to be active in the container or compute instance may be received. In parallel with step 502 or subsequent to step 502, the statuses of the registered agents may be received in step 503. In step 504, an available name of a registered agent (or a list of available names of registered agents) may be received. Step 504 may follow step 503 and/or follow step 501.

In step 505, the process may determine which agent instances are inactive. In step 506, the process receives an agent object corresponding to the type of inactive agent instance. In step 507, the process receives agent instance configuration information. In step 508, the process instantiates the inactive agent and connects it to the agent status server. In step 509, the process may determine whether the agent instance was successfully instantiated. If no, then steps 506 and 507 may be repeated. Further, if the agent instance did not successfully instantiate after a number of tries, then the process times out and inactivates the container in step 512.

In step 510, the agent instance may be connected to the batch job application and the batch job application deployed. In step 511, the process may determine whether the connection of the agent instance to the batch job application and/or the deployment of the batch job application was successful. If not, then the step 510 may be repeated. The newly instantiated agent may be inactivated and the agent re-instantiated in steps 506 and 507. Further, if the agent instance was not successfully connected with the batch job application and/or the batch job application did not successfully deploy, then the process times out and inactivates the container in step 512. If the agent instance was successfully connected with the batch job application and/or the batch job application was successfully deployed, then the awaits a new container creation in step 501.

FIG. 6 shows a flowchart of a process of keeping configuration information current for agent instances. After step 510 of FIG. 5, the configuration information of the newly instantiated agent instance may be stored in step 601 as agent configuration information 320 of FIG. 3. In step 602, status information of one or more agent instances may be periodically provided to the agent status server (e.g., agent status server 323 of FIG. 3).

As described herein, a computer-implemented method for instantiating agents in container may include determining whether a container, having a processing task performed by one or more instances of agents, has been deployed; receiving, based on a determination that the container has been deployed, a list of the one or more instances of agents for the container; and receiving, based on the determination and from an agent status server, statuses of the one or more instances of agents. The method may also include determining, based on the list of agents and the statuses of the one or more instances of the agents, whether an instance of an agent of the one or more instances of the agents is inactive; receiving, from an agent object repository and based on a determination that the instance of the agent is inactive, an agent object corresponding to the agent; receiving, from an agent configuration repository and based on a determination that the agent is inactive, configuration information for the instance of the agent; and attempting to instantiate, based on the agent object and the configuration information, the instance of the agent. The attempt to instantiate the instance of the agent may include attempting to connect the instance of the agent to the agent status server.

In additional aspects, the method may further include providing, to the agent status server, a status of the instance of the agent. In further aspects the method may include storing configuration information of the instance of the agent in the agent configuration repository. In yet further aspects the method may include determining, based on the attempt to instantiate the instance of the agent, whether the instantiation of the instance of the agent was successful; receiving, based on a determination that the attempt to instantiate the instance of the agent failed and from the agent object repository, a replacement agent object corresponding to the agent; receiving, from the agent configuration repository and based on the determination that the attempt to instantiate the instance of the agent failed, replacement configuration information for the instance of the agent; and attempting to instantiate, based on the replacement agent object and the replacement configuration information, a replacement instance of the agent.

In some aspects, the method may include retrieving a quantity threshold of attempts to instantiate the replacement instance of the agent; determining whether the quantity threshold of attempts has been satisfied and the replacement instance of the agent has not been successfully instantiated; and inactivating, based on a determination that the quantity threshold of attempts has been satisfied and the replacement instance of the agent has not been successfully instantiated, the container. In some aspects, the method may include attempting to connect, based on a successful attempt to instantiate the instance of the agent, the instance of the agent to the processing task in the container.

In some aspects, the method may include determining, based on the attempt to connect the instance of the agent, whether the attempt to connect the instance of the agent to the processing task was successful; receiving, based on a determination that the attempt to connect the instance of the agent to the processing task failed and from the agent object repository, a replacement agent object corresponding to the agent; receiving, from the agent configuration repository and based on the determination that the attempt to connect the instance of the agent to the processing task failed, replacement configuration information for the instance of the agent; instantiating, based on the replacement agent object and the replacement configuration information, a replacement instance of the agent; and attempting to connect, based on the instantiation of the replacement instance of the agent, the replacement instance of the agent to the processing task in the container.

In some aspects, the method may include retrieving a quantity threshold of attempts to connect the replacement instance of the agent to the processing task in the container; determining whether the quantity threshold of attempts has been satisfied and the replacement instance of the agent has not been successfully connected to the processing task; and inactivating, based on a determination that the quantity threshold of attempts has been satisfied and the replacement instance of the agent has not been successfully connected to the processing task, the container.

In one or more aspects, an apparatus may include one or more processors; and memory storing instructions that, when executed by the one or more processors, cause the apparatus to: determine whether a container, having a processing task performed by one or more instances of agents, has been deployed, wherein the container contains one or more instances of agents; receive, based on a determination that the container has been deployed, a list of the one or more instances of agents for the container; and receive, based on the determination and from an agent status server, statuses of the one or more instances of agents. The instructions may further cause the apparatus to determine, based on the list of agents and the statuses of the one or more instances of the agents, whether an instance of an agent of the one or more instances of the agents is inactive; receive, from an agent object repository and based on a determination that the instance of the agent is inactive, an agent object corresponding to the agent; receive, from an agent configuration repository and based on a determination that the agent is inactive, configuration information for the instance of the agent; and attempt to instantiate, based on the agent object and the configuration information, the instance of the agent.

The instructions may further cause the apparatus to attempt to connect the instance of the agent to the agent status server, provide, to the agent status server, a status of the instance of the agent, or store configuration information of the instance of the agent in the agent configuration repository. The instructions may further cause the apparatus to determine, based on the attempt to instantiate the instance of the agent, whether the instantiation of the instance of the agent was successful; receive, based on a determination that the attempt to instantiate the instance of the agent failed and from the agent object repository, a replacement agent object corresponding to the agent; receive, from the agent configuration repository and based on the determination that the attempt to instantiate the instance of the agent failed, replacement configuration information for the instance of the agent; and attempt to instantiate, based on the replacement agent object and the replacement configuration information, a replacement instance of the agent.

The instructions may further cause the apparatus to retrieve a quantity threshold of attempts to instantiate the replacement instance of the agent; determine whether the quantity threshold of attempts has been satisfied and the replacement instance of the agent has not been successfully instantiated; and inactivate, based on a determination that the quantity threshold of attempts has been satisfied and the replacement instance of the agent has not been successfully instantiated, the container. The instructions may further cause the apparatus to attempt to connect, based on a successful attempt to instantiate the instance of the agent, the instance of the agent to the processing task in the container.

The instructions may further cause the apparatus to determine, based on the attempt to connect the instance of the agent, whether the attempt to connect the instance of the agent to the processing task was successful; receive, based on a determination that the attempt to connect the instance of the agent to the processing task failed and from the agent object repository, a replacement agent object corresponding to the agent; receive, from the agent configuration repository and based on the determination that the attempt to connect the instance of the agent to the processing task failed, replacement configuration information for the instance of the agent; instantiate, based on the replacement agent object and the replacement configuration information, a replacement instance of the agent; and attempt to connect, based on the instantiation of the replacement instance of the agent, the replacement instance of the agent to the processing task in the container.

The instructions may further cause the apparatus to retrieve a quantity threshold of attempts to connect the replacement instance of the agent to the processing task in the container; determine whether the quantity threshold of attempts has been satisfied and the replacement instance of the agent has not been successfully connected to the processing task; and inactivate, based on a determination that the quantity threshold of attempts has been satisfied and the replacement instance of the agent has not been successfully connected to the processing task, the container.

One or more non-transitory media storing instructions that, when executed by one or more processors, cause the one or more processors to perform steps including: determining whether a container, having a processing task performed by one or more instances of agents, has been deployed; receiving, based on a determination that the container has been deployed, a list of the one or more instances of agents for the container; and receiving, based on the determination and from an agent status server, statuses of the one or more instances of agents. The instructions may cause the one or more processors to perform further steps including: determining, based on the list of agents and the statuses of the one or more instances of the agents, whether an instance of an agent of the one or more instances of the agents is inactive; receiving, from an agent object repository and based on a determination that the instance of the agent is inactive, an agent object corresponding to the agent; receiving, from an agent configuration repository and based on a determination that the agent is inactive, configuration information for the instance of the agent; attempting to instantiate, based on the agent object and the configuration information, the instance of the agent; and connecting, based on the instantiation of the agent, the instance of the agent to the processing task in the container.

In some aspects, the instructions may further cause the one or more processors to store configuration information of the instance of the agent in the agent configuration repository.

Other embodiments of this aspect include corresponding computer systems, apparatus, and computer programs recorded on one or more computer storage devices, each configured to perform the actions of the methods.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for instantiating agents in containers, the method comprising:
determining whether a container, having a processing task performed by an instance of an agent, has been deployed;
receiving, based on a determination that the container has been deployed, a list of the one or more instances of the agents for the container;
receiving, based on the determination and from an agent status server, statuses of the one or more instances of the agents;
determining, based on the list of agents and the statuses of the one or more instances of the agents, whether an instance of an agent of the one or more instances of the agents is inactive;
receiving, from an agent object repository and based on a determination that the instance of the agent is inactive, an agent object corresponding to the agent;
receiving, from an agent configuration repository and based on a determination that the agent is inactive, configuration information for the instance of the agent; and
attempting to instantiate, based on the agent object and the configuration information, the instance of the agent.

2. The computer-implemented method of claim 1, wherein attempting to instantiate the instance of the agent comprises attempting to connect the instance of the agent to the agent status server.

3. The computer-implemented method of claim 1, further comprising:
providing, to the agent status server, a status of the instance of the agent.

4. The computer-implemented method of claim 1, further comprising:
storing configuration information of the instance of the agent in the agent configuration repository.

5. The computer-implemented method of claim 1, further comprising:
determining, based on the attempt to instantiate the instance of the agent, whether the instantiation of the instance of the agent was successful;
receiving, based on a determination that the attempt to instantiate the instance of the agent failed and from the agent object repository, a replacement agent object corresponding to the agent;
receiving, from the agent configuration repository and based on the determination that the attempt to instantiate the instance of the agent failed, replacement configuration information for the instance of the agent; and
attempting to instantiate, based on the replacement agent object and the replacement configuration information, a replacement instance of the agent.

6. The computer-implemented method of claim 5, further comprising:
retrieving a quantity threshold of attempts to instantiate the replacement instance of the agent;
determining whether the quantity threshold of attempts has been satisfied and the replacement instance of the agent has not been successfully instantiated; and
inactivating, based on a determination that the quantity threshold of attempts has been satisfied and the replacement instance of the agent has not been successfully instantiated, the container.

7. The computer-implemented method of claim 1, further comprising:
attempting to connect, based on a successful attempt to instantiate the instance of the agent, the instance of the agent to the processing task performed by the container.

8. The computer-implemented method of claim 7, further comprising:
determining, based on the attempt to connect the instance of the agent, whether the attempt to connect the instance of the agent to the processing task was successful;
receiving, based on a determination that the attempt to connect the instance of the agent to the processing task failed and from the agent object repository, a replacement agent object corresponding to the agent;
receiving, from the agent configuration repository and based on the determination that the attempt to connect the instance of the agent to the processing task failed, replacement configuration information for the instance of the agent;
instantiating, based on the replacement agent object and the replacement configuration information, a replacement instance of the agent; and
attempting to connect, based on the instantiation of the replacement instance of the agent, the replacement instance of the agent in the container to the processing task.

9. The computer-implemented method of claim 8, further comprising:
retrieving a quantity threshold of attempts to connect the replacement instance of the agent in the container to the processing task;
determining whether the quantity threshold of attempts has been satisfied and the replacement instance of the agent has not been successfully connected to the processing task; and
inactivating, based on a determination that the quantity threshold of attempts has been satisfied and the replacement instance of the agent has not been successfully connected to the processing task, the container.

10. An apparatus comprising:
one or more processors; and
memory storing instructions that, when executed by the one or more processors, cause the apparatus to:
determine whether a container, having a processing task performed by one or more instances of agents, has been deployed, wherein the container is controlled by the one or more instances of the agents;
receive, based on a determination that the container has been deployed, a list of the one or more instances of the agents for the container;
receive, based on the determination and from an agent status server, statuses of the one or more instances of the agents;
determine, based on the list of agents and the statuses of the one or more instances of the agents, whether an instance of an agent of the one or more instances of the agents is inactive;
receive, from an agent object repository and based on a determination that the instance of the agent is inactive, an agent object corresponding to the agent;
receive, from an agent configuration repository and based on a determination that the agent is inactive, configuration information for the instance of the agent; and
attempt to instantiate, based on the agent object and the configuration information, the instance of the agent.

11. The apparatus of claim 10, wherein the instructions to attempt to instantiate of the instance of the agent cause the apparatus to attempt to connect the instance of the agent to the agent status server.

12. The apparatus of claim 10, wherein the instructions further cause the apparatus to:
provide, to the agent status server, a status of the instance of the agent.

13. The apparatus of claim 10, wherein the instructions further cause the apparatus to:
store configuration information of the instance of the agent in the agent configuration repository.

14. The apparatus of claim 10, wherein the instructions further cause the apparatus to:
determine, based on the attempt to instantiate the instance of the agent, whether the instantiation of the instance of the agent was successful;
receive, based on a determination that the attempt to instantiate the instance of the agent failed and from the agent object repository, a replacement agent object corresponding to the agent;
receive, from the agent configuration repository and based on the determination that the attempt to instantiate the instance of the agent failed, replacement configuration information for the instance of the agent; and
attempt to instantiate, based on the replacement agent object and the replacement configuration information, a replacement instance of the agent.

15. The apparatus of claim 14, wherein the instructions further cause the apparatus to:
retrieve a quantity threshold of attempts to instantiate the replacement instance of the agent;
determine whether the quantity threshold of attempts has been satisfied and the replacement instance of the agent has not been successfully instantiated; and
inactivate, based on a determination that the quantity threshold of attempts has been satisfied and the replacement instance of the agent has not been successfully instantiated, the container.

16. The apparatus of claim 10, wherein the instructions further cause the apparatus to:
attempt to connect, based on a successful attempt to instantiate the instance of the agent, the instance of the agent to the processing task in the container.

17. The apparatus of claim 16, wherein the instructions further cause the apparatus to:
determine, based on the attempt to connect the instance of the agent, whether the attempt to connect the instance of the agent to the processing task was successful;
receive, based on a determination that the attempt to connect the instance of the agent to the processing task failed and from the agent object repository, a replacement agent object corresponding to the agent;
receive, from the agent configuration repository and based on the determination that the attempt to connect the instance of the agent to the processing task failed, replacement configuration information for the instance of the agent;
instantiate, based on the replacement agent object and the replacement configuration information, a replacement instance of the agent; and
attempt to connect, based on the instantiation of the replacement instance of the agent, the replacement instance of the agent to the processing task in the container.

18. The apparatus of claim 17, wherein the instructions further cause the apparatus to:
retrieve a quantity threshold of attempts to connect the replacement instance of the agent to the processing task in the container;
determine whether the quantity threshold of attempts has been satisfied and the replacement instance of the agent has not been successfully connected to the processing task; and
inactivate, based on a determination that the quantity threshold of attempts has been satisfied and the replacement instance of the agent has not been successfully connected to the processing task, the container.

19. One or more non-transitory media storing instructions that, when executed by one or more processors, cause the one or more processors to perform steps comprising:
determining whether a container, having a processing task performed by one or more instances of the agents, has been deployed;
receiving, based on a determination that the container has been deployed, a list of the one or more instances of the agents for the container;
receiving, based on the determination and from an agent status server, statuses of the one or more instances of the agents;
determining, based on the list of agents and the statuses of the one or more instances of the agents, whether an instance of an agent of the one or more instances of the agents is inactive;
receiving, from an agent object repository and based on a determination that the instance of the agent is inactive, an agent object corresponding to the agent;
receiving, from an agent configuration repository and based on a determination that the agent is inactive, configuration information for the instance of the agent;
attempting to instantiate, based on the agent object and the configuration information, the instance of the agent; and
connecting, based on the instantiation of the agent, the instance of the agent to the processing task performed in the container.

20. One or more non-transitory media storing of claim 19, wherein the instructions further cause the one or more processors to perform steps comprising:
storing configuration information of the instance of the agent in the agent configuration repository.
